(19) United States
(12) Patent Application Publication
(10) Pub. No.: US 2010/0020104 A1
(43) Pub. Date: Jan. 28, 2010

(54) DISPLAY PROCESSING DEVICE, DISPLAY PROCESSING METHOD, AND DISPLAY PROCESSING PROGRAM

(75) Inventor: Tatsuaki Mitsumata, Nara (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/523,129

(22) PCT Filed: Jan. 11, 2008
(86) PCT No.: PCT/JP2008/050294

§ 371 Date: Jul. 14, 2009

(30) Foreign Application Priority Data
Jan. 15, 2007 (JP) 2007-005308

(51) Int. Cl. G09G 5/00

(52) U.S. Cl. 345/660

(57) ABSTRACT

The height and width of a GUI component are defined in advance using a reference height and a reference width. The height of a character inserted in the GUI component is defined in advance using the reference height. When the GUI component is displayed on a display unit, the reference height and the reference width of a reference font size are set to values corresponding to resolution of the display unit. When a panel with resolution of 1024×768 is used as the display unit, for example, the reference height is set to 25 and the reference width is set to 19. When a panel with resolution of 640×480 is used as the display unit, each of the reference height and the reference width is set to 16.

### TECHNICAL FIELD

The present invention relates to a display processing apparatus, a display processing method and a display processing program for performing processing for displaying graphic images on a screen of a display device.

### BACKGROUND ART

Graphic images such as characters, numbers, signs and figures other than video of a broadcast program are displayed on a television receiver. For example, GUI (Graphical User Interface) for various settings of the television receiver is represented by the graphic images. The graphic images for various settings of luminance, contrast, sharpness and so on are displayed on a screen. In addition, graphic images expressing an electronic program listing provided through digital broadcasting are displayed. Furthermore, on-screen display of graphic images expressing numbers or characters indicating channel or the like is provided.

Such graphic images are created in advance by a program. One dot of the graphic image corresponds to one pixel of the screen of a display device. Hereinafter, correspondence between one dot of the graphic image and one pixel of the screen is referred to as dot-by-dot.

Meanwhile, television receivers with large screens have recently been sold, promoting diversity in screen sizes. Therefore, each screen size has a different display resolution.

When the graphic image created for a small-sized television receiver is directly applied to a large-sized television receiver, the graphic image in small size is displayed on the large screen. Therefore, one dot of the graphic image is linked to a plurality of pixels of the screen, thereby enlarging the graphic image. However, enlarging the graphic image leads to degradation of image quality.

An image display apparatus that interpolates the pixels by a linear interpolation method or the like when enlarging the graphic image has been proposed for preventing degradation of the image quality (see Patent Document 1, for example).

[Patent Document 1] JP 2003-338991 A

### DISCLOSURE OF THE INVENTION

### [Problems to be Solved by the Invention]

When the image display apparatus that interpolates the pixels is applied to display on the large screen such as a plasma display panel, however, the overall graphic image appears blurred.

Therefore, the graphic image is created dot-by-dot for each resolution to display the graphic image corresponding to the resolution, so that a clear graphic image corresponding to the resolution can be displayed on the screen. In this case, the sizes (the number of dots in height and width) of a plurality of components such as characters, numbers, signs and figures constituting the graphic image are set corresponding to the resolution, and display data of each component with the set size is generated.

However, increased kinds of resolutions due to diversification of the screen sizes need much labor and time for generating the display data in the case of generating the display data of each component dot-by-dot for each resolution.

An object of the present invention is to provide a display processing apparatus, a display processing method and a display processing program for allowing graphic images with high definition to be displayed by common processing on a display device having different resolutions.

### [Means for Solving the Problems]

(1) According to an aspect of the present invention, a display processing apparatus that performs processing for displaying a graphic image on a screen of a display device includes a display information storage storing display information that defines a display component constituting the graphic image to be displayed on the screen, a reference size storage storing values of reference sizes that are preset for a plurality of resolutions and correspond to the respective resolutions, a component information storage storing component information that defines a size of the display component for each type of the display component, a resolution acquirer acquiring the resolution of the screen of the display device, a reference size acquirer acquiring the value of the reference size corresponding to the resolution acquired by the resolution acquirer from the reference size storage, and a display data generator calculating the size of the display component defined by the display information stored in the display information storage based on the value of the reference size acquired by the reference size acquirer and the component information stored in the component information storage, and generating display data for displaying the display component based on the calculated size.

In the display processing apparatus, the display information that defines the display component constituting the graphic image to be displayed on the screen of the display device is stored by the display information storage, and the values of the reference sizes that are preset for the plurality of resolutions and correspond to the respective resolutions are stored by the reference size storage. In addition, the component information that defines the size of the display component for each type of the display component is stored by the component information storage.

The resolution of the screen of the display device is acquired by the resolution acquirer, and the value of the reference size corresponding to the acquired resolution is acquired from the reference size storage by the reference size acquirer. The size of the display component defined by the display information is calculated by the display data generator and the display data for displaying the display component is generated based on the value of the acquired reference size and the component information stored in the component information storage.

In this manner, the size of the display component constituting the graphic image is calculated based on the value of the reference size corresponding to the resolution of the screen of the display device and the component information stored in the component information storage. In this case, the common component information can be used for the plurality of resolutions. Accordingly, the display data for displaying the graphic image with high definition on the display device having different resolutions can be generated by common processing. This reduces labor and time for creating the graphic image.

(2) The component information may define the size of the display component by a variable of the reference size. In this case, the size of the display component constituting the graphic image can be easily calculated based on the value of the reference size corresponding to the resolution of the screen of the display device and the component information stored in the component information storage. This further reduces labor and time for creating the graphic image.

(3) The display processing apparatus may further include a display position calculator calculating a display position of the display component on the screen based on the size of the display component calculated by the display data generator.

In this case, the display position of the display component on the screen is calculated by the display position calculator based on the size of the display component calculated by the display data generator, and therefore it is not necessary to preset the display position of the display component on the screen in the absolute coordinate on the screen. This further reduces labor and time for creating the graphic image.

(4) The display position calculator may sequentially calculate, when the graphic image to be displayed on the screen includes a plurality of display components, display positions of the display components such that the plurality of display components are sequentially arranged on the screen with a predetermined reference position on the screen as a reference based on the size of each display component calculated by the display data generator.

In this case, it is not necessary to preset the display positions of the plurality of display components on the screen in the absolute coordinate on the screen for each display component, thus allowing the display positions of the plurality of display components to be easily set. This further reduces labor and time for creating the graphic image.

(5) The graphic image may be displayed in a display region formed in at least part of the screen, and the display processing apparatus may further include a display region calculator that calculates a size of the display region based on the size of the display component calculated by the display data generator.

In this case, the size of the display region is calculated by the display region calculator based on the size of the display component calculated by the display data generator, and therefore it is not necessary to preset the size of the display region for each graphic image. This further reduces labor and time for creating the graphic image.

(6) The display processing apparatus may further include a size modifier that modifies the size of the display component calculated by the display data calculator such that a margin of the display region calculated by the display region calculator is reduced.

In this case, the size of the display component calculated by the display data calculator is modified, so that the display component is displayed with good balance in the display region.

(7) The reference size may include a reference height and a reference width in dot units.

In this case, the size of the display component in a height direction and a width direction can be calculated in dot units. This allows the graphic image with higher definition to be displayed on display devices of various resolutions.

(8) According to another aspect of the present invention, a display processing method for performing processing for displaying a graphic image on a screen of a display device includes the steps of storing display information that defines a display component constituting a graphic image to be displayed on the screen, storing values of reference sizes that are preset for a plurality of resolutions and correspond to the respective resolutions, storing component information that defines a size of the display component for each type of the display component by a variable of the reference size, acquiring a resolution of the screen of the display device, determining the value of the reference size corresponding to the acquired resolution based on the values of the reference sizes corresponding to the plurality of resolutions that have been stored, and calculating the size of the display component defined by the stored display information based on the determined value of the reference size and the stored component information, and generating the display data for displaying the display component based on the calculated size.

According to the display processing method, the size of the display component constituting the graphic image is calculated based on the value of the reference size corresponding to the resolution of the screen of the display device and the stored component information. In this case, the component information defines the size of the display component by the variable of the reference size, and therefore the common component information can be used for the plurality of resolutions. Accordingly, the display data for displaying the graphic image with high definition on the display device having different resolutions can be generated by common processing. This reduces labor and time for creating the graphic image.

(9) The component information may define the size of the display component by a variable of the reference size. In this case, the size of the display component constituting the graphic image can be easily calculated based on the value of the reference size corresponding to the resolution of the screen of the display device and the component information stored in the component information storage. This further reduces labor and time for creating the graphic image.

(10) According to still another aspect of the present invention, a display processing program that can be executed by a processing apparatus that performs processing for displaying a graphic image on a screen of a display device, causing the processing apparatus to execute the processes of storing display information that defines a display component constituting a graphic image to be displayed on the screen, storing values of reference sizes that are preset for a plurality of resolutions and correspond to the respective resolutions, storing component information that defines a size of a display component for each type of the display component by a variable of the reference size, acquiring a resolution of the screen of the display device, determining the value of the reference size corresponding to the acquired resolution based on the values of the reference sizes corresponding to the plurality of resolutions that have been stored, and calculating the size of the display component defined by the stored display information based on the determined value of the reference size and the stored component information, and generating the display data for displaying the display component based on the calculated size.

According to the display processing program, the size of the display component constituting the graphic image is calculated based on the value of the reference size corresponding to the resolution of the screen of the display device and the stored component information. In this case, the component information defines the size of the display component by the variable of the reference size, and therefore the common component information can be used for the plurality of resolutions. Accordingly, the display data for displaying the graphic image with high definition on the display device having different resolutions can be generated by common processing. This reduces labor and time for creating the graphic image.

(11) The component information may define the size of the display component by a variable of the reference size. In this case, the size of the display component constituting the graphic image can be easily calculated based on the value of the reference size corresponding to the resolution of the screen of the display device and the component information stored in the component information storage. This further reduces labor and time for creating the graphic image.

### EFFECT OF THE INVENTION

According to the present invention, display data for displaying a graphic image with high definition in a display device having different resolutions can be generated by common processing. This reduces labor and time for creating the graphic image.

### BRIEF DESCRIPTION OF THE DRAWINGS

FIG. 1 is a block diagram showing the configuration of a display processing apparatus according to one embodiment of the present invention.

FIG. 2 is a diagram showing a processing program and processing tables stored in a ROM.

FIG. 3 is a diagram showing one example of a reference font size definition table.

FIG. 4 is a schematic view showing an example of calculation of display data of a GUI component.

FIG. 5 is a schematic view showing the example of calculation of the display data of the GUI component.

FIG. 6 is a diagram for explaining display of a character on a display unit.

FIG. 7 is a diagram showing one example of a GUI image.

FIG. 8 is a diagram schematically showing a screen definition list corresponding to the GUI image of FIG. 7.

FIG. 9 is a diagram showing another example of the GUI image.

FIG. 10 is a diagram schematically showing a screen definition list corresponding to the GUI image of FIG. 9.

FIG. 11 is a diagram showing a specific example of a component definition table.

FIG. 12 is a flowchart showing one example of GUI display processing performed by a CPU.

FIG. 13 is a flowchart showing the one example of the GUI display processing performed by the CPU.

FIG. 14 is a flowchart showing the one example of the GUI display processing performed by the CPU.

FIG. 15 is a flowchart showing the one example of the GUI display processing performed by the CPU.

FIG. 16 is a flowchart showing the one example of the GUI display processing performed by the CPU.

### BEST MODE FOR CARRYING OUT THE INVENTION

Hereinafter, a display processing apparatus according to one embodiment of the present invention will be described. Note that description is made of processing of a GUI (Graphical User Interface) image as an example of a graphic image in the following embodiment.

### (1) Configuration of Display Processing Apparatus

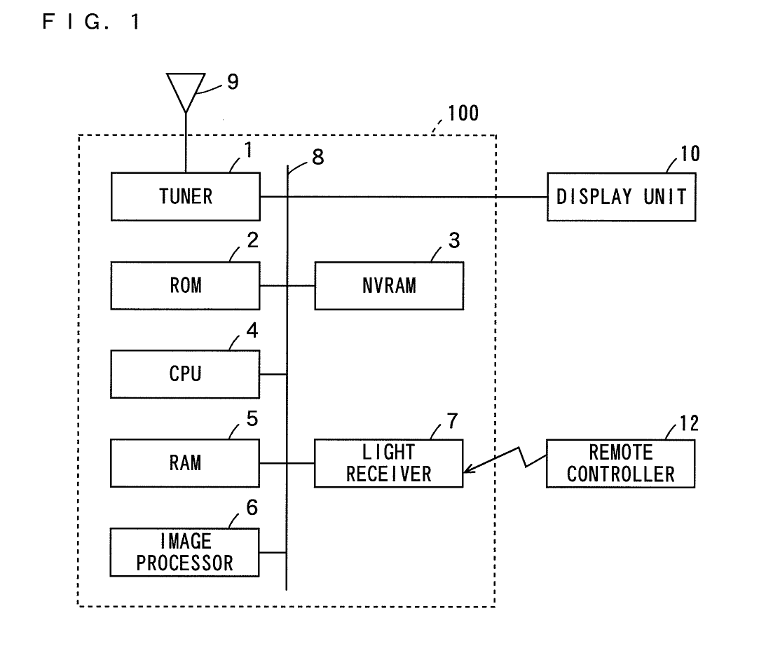

FIG. 1 is a block diagram showing the configuration of the display processing apparatus according to one embodiment of the present invention. As shown in FIG. 1, the display processing apparatus 100 includes a tuner 1, a ROM (Read Only Memory) 2, an NVRAM (Nonvolatile Random Access Memory) 3, a CPU (Central Processing Unit) 4, a RAM (Random Access Memory) 5, an image processor 6 and a light receiver 7. These functional units are connected to one another through bus 8. In addition, an antenna 9 and a display unit 10 are connected to the display processing apparatus 100.

The tuner 1 performs channel selection by selecting a frequency of a television broadcast signal (a digital broadcast signal, for example) input from the antenna 9. In addition, the tuner 1 demodulates and decodes video data and audio data from the selected television broadcast signal. The ROM 2 stores various processing programs and processing tables. The NVRAM 3 temporarily stores a channel, a sound volume and so on set by a user while storing model information of the display unit 10 and so on.

The CPU 4 controls each functional unit of the display processing apparatus 100 while creating GUI image data by GUI display processing, described later. The RAM 5 functions as a processing area for the CPU 4 to execute various kinds of processing. The image processor 6 draws a GUI image based on the GUI image data generated by the CPU 3.

The light receiver 7 receives an infrared signal from a remote controller 12, and outputs an electric signal based on the infrared signal. Note that in the present embodiment, a predetermined operation of the remote controller 12 performed by a user causes the light receiver 7 to output a display command signal. The CPU 4 starts the GUI display processing based on the display command signal. Details will be described later.

The display unit 10 includes a display panel that allows display in dot units such as a liquid crystal display, a plasma display or the like, and an audio output device such as a speaker. The display unit 10 displays the video data output from the tuner 1 as video while outputting the audio data as audio. In addition, the display unit 10 displays the GUI image drawn by the image processor 6.

### (2) Processing Program and Processing Table

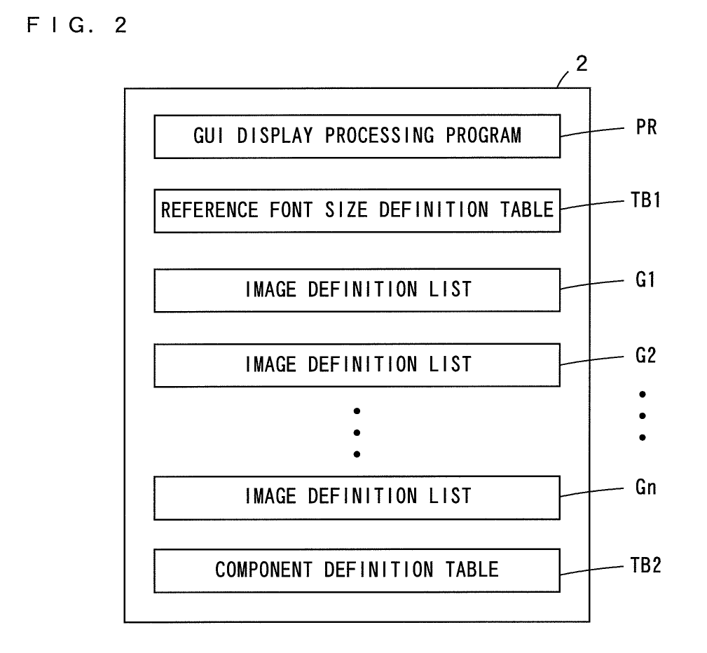

FIG. 2 is a diagram showing the processing program and the processing tables stored in the ROM 2. As shown in FIG. 2, the ROM 2 stores a GUI display processing program PR, a reference font size definition table TB1, screen definition lists G1, G2, . . . , Gn (n is a natural number) and a component definition table TB2.

The GUI display processing program PR is an application program for the CPU 4 to perform the GUI display processing. A reference font size, described later, is defined in the reference font size definition table TB1. Each of the screen definition lists G1, G2, . . . , Gn has information corresponding to the GUI image. Various components constituting the GUI image are defined in the component definition table TB2. Details of the processing program and the processing tables will be described later.

### (3) The Reference Font Size

In the display processing apparatus 100, the reference font size as a base unit for creating the GUI image is determined based on the reference font size definition table TB1. Details will be described below.

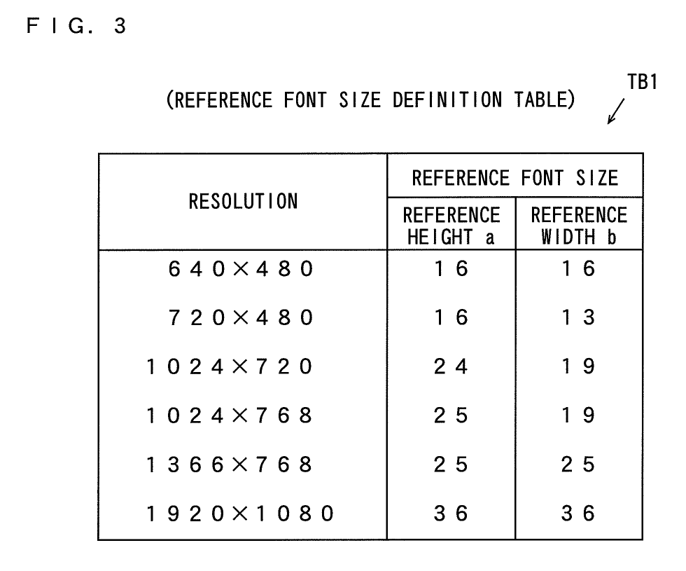

FIG. 3 is a diagram showing one example of the reference font size definition table TB1. As shown in FIG. 3, the reference font sizes each composed of a reference height a [dot] and a reference width b [dot] are set corresponding to various resolutions of the display unit 10 in the reference font size definition table TB1.

Note that a pixel has a square shape in the display unit 10 with the resolution of 640×480, 1366×768 or 1920×1080.

Meanwhile, a pixel has a horizontally long rectangular shape in the display unit 10 with the resolution of 720×480, 1024×720 or 1024×768. When the pixel of the display unit 100 has the square shape, the reference height a and the reference width b of the reference font size are set to be equal. When the pixel of the display unit 10 has the horizontally long rectangular shape, the reference height a is set larger than the reference width b.

In the present embodiment, the display data such as the height and width of the components constituting the GUI image is calculated in dot units based on the reference font size. A specific example is shown below. Note that the components constituting the GUI image are referred to as GUI components in the following description.

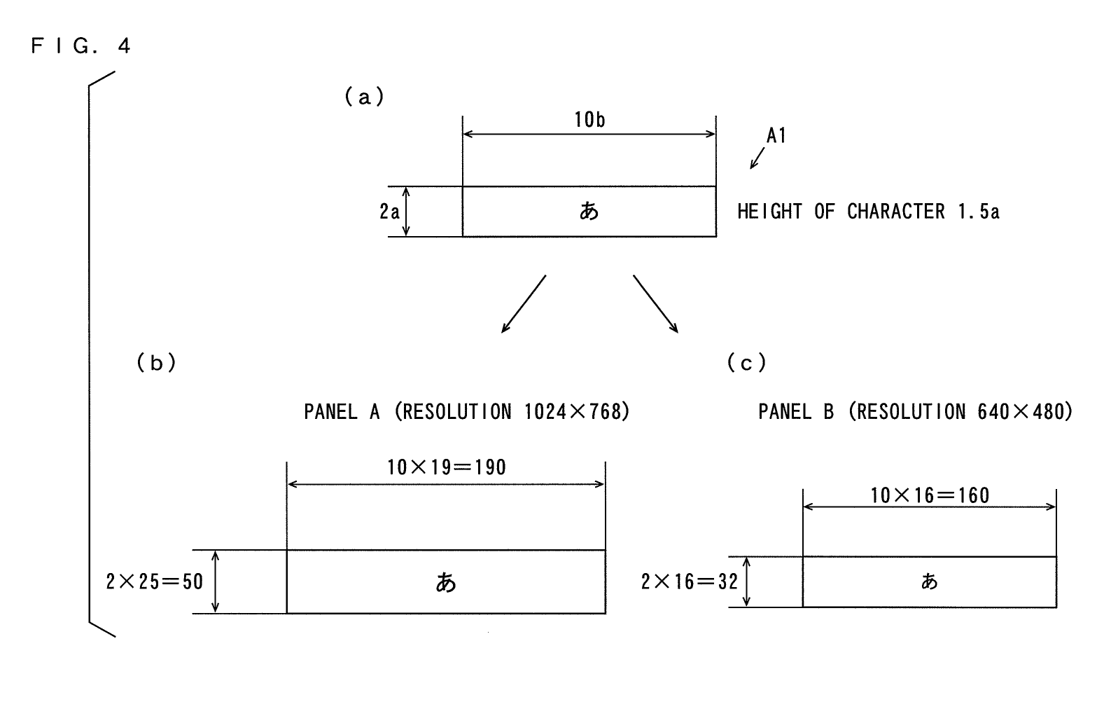

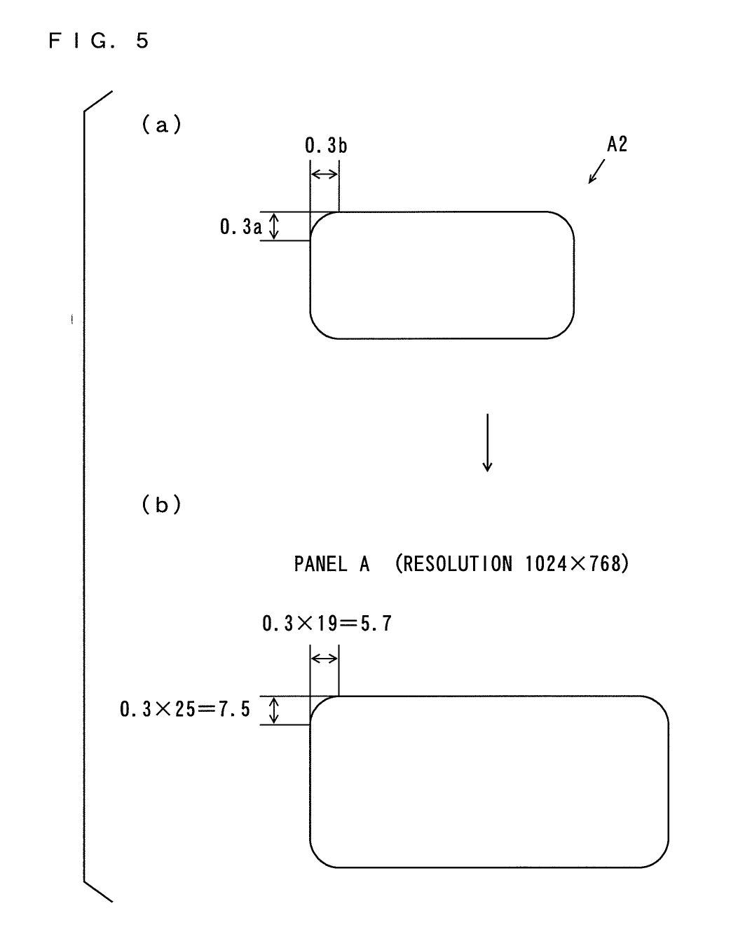

FIGS. 4 and 5 are schematic views showing an example of calculation of the display data of the GUI component. In FIG. 4, the display data of a rectangular GUI component A1 is calculated. First, the height and width of the GUI component A1 is defined in advance using the reference height a and the reference width b as shown in FIG. 4(a). In the example of FIG. 4, the height of the GUI component A1 is 2 times as high as the reference height, and the width of the GUI component A1 is 10 times as wide as the reference width b.

Also, the height of a character inserted in the GUI component A1 is defined in advance using the reference height a. In the example of FIG. 4, the height of the character inserted in the GUI component A1 is 1.5 times as high as the reference height a. Note that a magnification of the reference height a defined as the height of the character is applied as a magnification of the reference width b, thereby determining the width of the character. That is, the width of the character is 1.5 times as wide as the reference width b in the example of FIG. 4.

When the GUI component A1 is displayed on the display unit 10, the reference height a and the reference width b of the reference font size are set to values corresponding to the resolution of the display unit 10 based on the reference font size table TB1 of FIG. 3. When a panel A with resolution of 1024×768 is used as the display unit 10 as shown in FIG. 4(b), for example, the reference height a is set to 25 and the reference width b is set to 19 (see FIG. 3). Accordingly, the height of the GUI component A1 is 50 dots (2×25=50) and the width thereof is 190 dots (10×19=190).

The height of the character inserted in the GUI component A1 is 37.5 dots (1.5×25=37.5), and the width thereof is 28.5 dots (1.5×19=28.5). When the calculated value is not a natural number, the fractional portion of the value is dropped, rounded up or rounded off. When the fractional portion is dropped, the height of the character inserted in the GUI component A1 is 37 dots, and the width thereof is 28 dots.

When a panel B with resolution of 640×480 is used as the display unit 10 as shown in FIG. 4(c), the reference height a is set to 16, and the reference width b is set to 16 (see FIG. 3). In this case, the height of the GUI component A1 is 32 dots (2×16=32) and the width thereof is 160 dots (10×16=160). Each of the height and the width of the character inserted in the GUI component A1 is 24 dots (1.5×16=24).

In this manner, the height and width of the GUI component A1 and the height and width of the inserted character are calculated in dot units depending on the resolution of the display unit 10.

In the case of rounding a corner of the rectangular GUI component, a formation region and so on of the roundness is calculated based on the reference font size. Description is made of a case where a corner of a rectangular GUI component A2 is rounded with reference to FIG. 5. As shown in FIG. 5(a), a formation region of the roundness of the GUI component A2 is defined in advance using the reference height a and the reference width b. In the example of FIG. 5, the formation height of the roundness of the GUI component A2 is 0.3 time the reference height a, and the formation width thereof is 0.3 time the reference width b. When the panel A with the resolution of 1024×768 is used as the display unit 10, the reference height a is set to 25 and the reference width b is set to 19 as shown in FIG. 5(b). In this case, the formation height of the roundness of the component A2 is 7.5 dots (0.3×25=7.5), and the formation width thereof is 5.7 dots (0.3×19=5.7). When the fraction portions are dropped, the formation height of the roundness at the corner of the component A2 is 7 dots, and the width thereof is 5 dots.

Also in the case of displaying a circular GUI component or a polygonal GUI component, the display data is calculated in dot units based on the reference font size similarly to the foregoing.

### (3-a) Display of the Character

Display of the character on the display unit 10 will now be described in detail. Here, description is made of cases where the character provided with common definition is displayed on the display unit 10 having pixels of the square shape and the display unit 10 having pixels of the horizontally long rectangular shape.

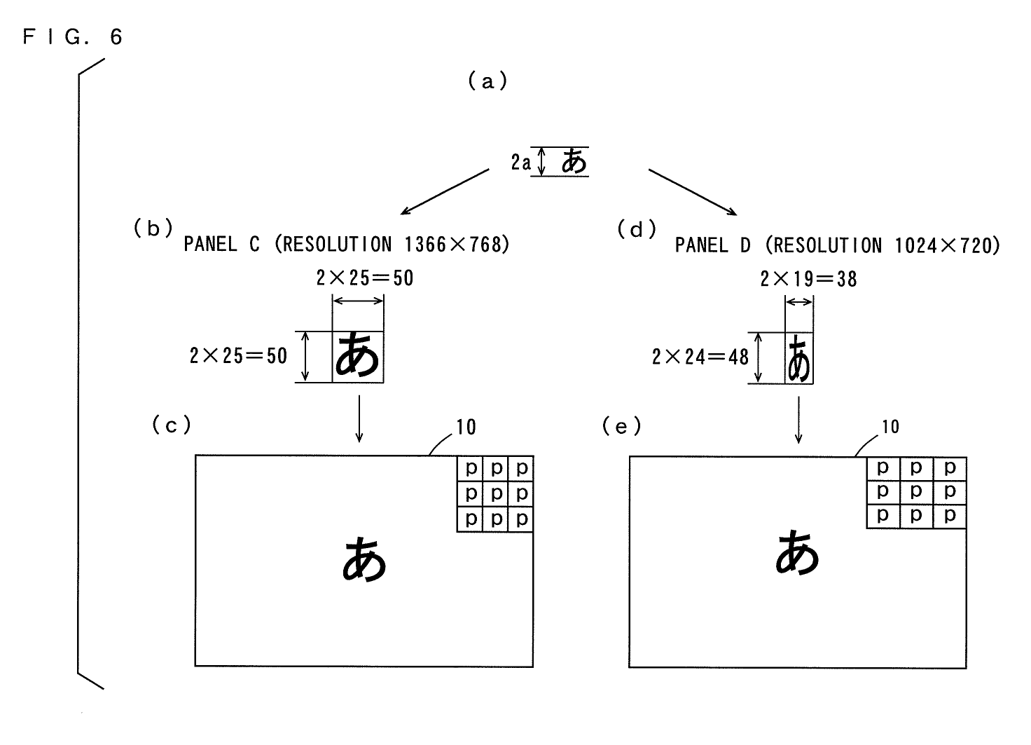

FIG. 6 is a diagram for explaining display of the character on the display unit 10. It is defined that the height of the character is 2 times as high as the reference height a as shown in FIG. 6(a). In this case, the width of the character is 2 times as wide as the reference width b.

As shown in FIG. 6(b), when a panel C with resolution of 1366×768 is used as the display unit 10, each of the reference height a and the reference width b is set to 25 (see FIG. 3). Thus, each of the height and width of the character is 50 dots (2×25=50). As shown in FIG. 6(c), a pixel p of the panel C has the square shape. Therefore, when the height and width of the character calculated in dot units are equal, the character with the equal height and width is displayed on the panel C.

Meanwhile, when a panel D with resolution of 1024×720 is used as the display unit 10, the reference height a is set to 24, and the reference width b is set to 19 as shown in FIG. 6(d). Thus, the height of the character is 48 dots (2×24=48) and the width thereof is 38 dots (2×19=38). That is, the character is vertically long in dot units. However, since the pixel p of the panel D has the horizontally long rectangular shape, the character with the equal height and width is displayed on the panel D as shown in FIG. 6(e).

As described above, the shape of the character does not change according to the shape of the pixels of the display units 10, so that the character in a normal state that can be easily viewed by a user can be displayed on various display units 10 in the present embodiment. Note that a constant aspect ratio can be maintained also when a figure or the like other than the character is displayed on the display unit 10.

### (4) Specific Examples of the GUI Image, the Screen definition List and the Component Definition Table

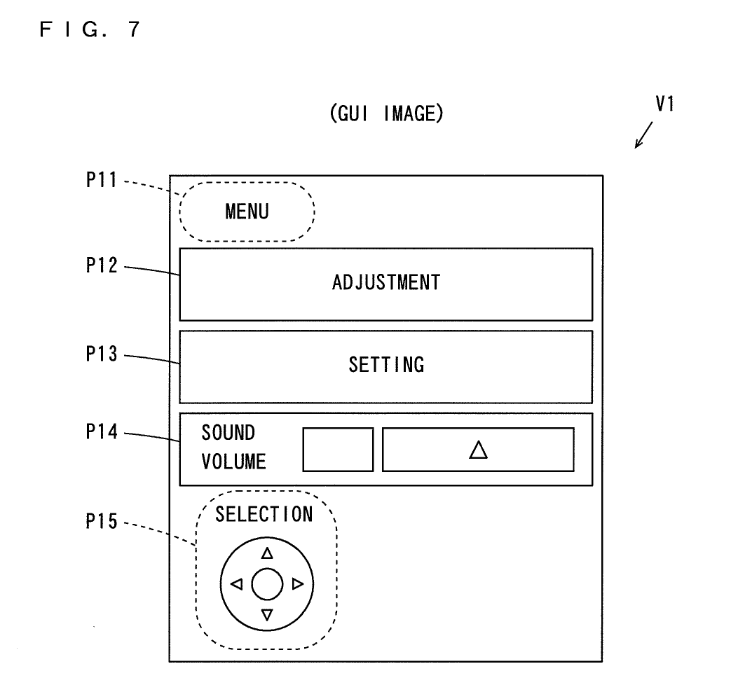

Next, description is made of specific examples of the GUI image, the screen definition list and the component definition table TB2. FIG. 7 is a diagram showing one example of the GUI image. Note that the GUI image V1 shown in FIG. 7 is a window display type GUI image displayed at part of the screen of the display unit 10 as a window. As shown in FIG. 7, the GUI image V1 includes a title component P11, button components P12, P13, a volume component P14 and a guide component 15 as the GUI components.

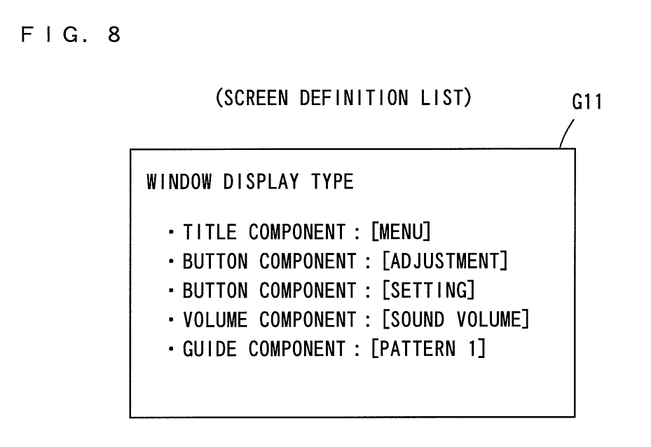

FIG. 8 is a diagram schematically showing the screen definition list corresponding to the GUI image V1 of FIG. 7. As shown in FIG. 8, the display type of the GUI image V1, the type of the GUI components included in the GUI image V1, and the characters inserted in each GUI component are shown in the screen definition list G11. A type of shapes (patterns) is indicated in the guide component P15.

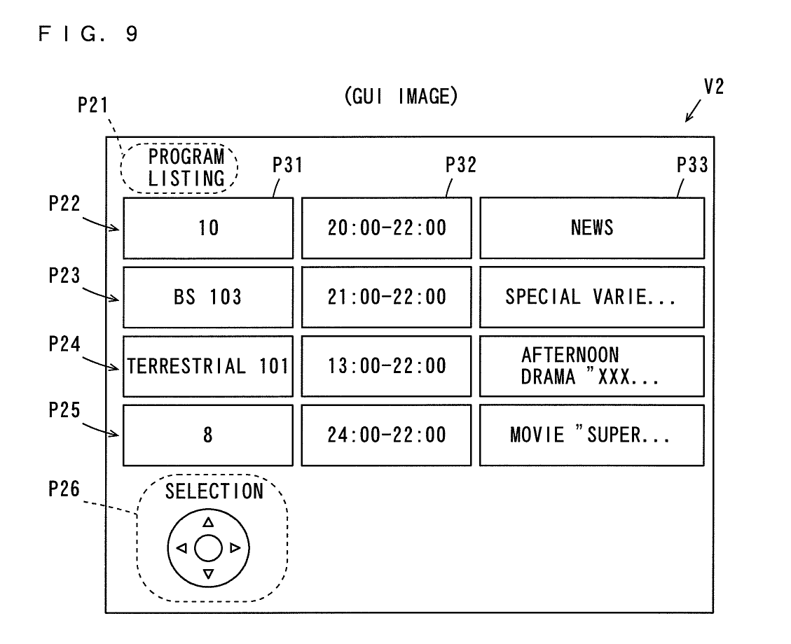

FIG. 9 is a diagram showing another example of the GUI image. A GUI image V2 shown in FIG. 9 is a whole screen display type GUI image displayed on the whole screen of the display unit 10, representing an example of an electronic program listing provided through digital broadcasting. As shown in FIG. 9, the GUI image V2 includes a title component P21, list components P22, P23, P24, P25 and a guide component P26 as the GUI components. Each of the list components P22, P23, P24, P25 is composed of a channel component P31, a time component P32 and a program contents component P33. In the following description, the plurality of components (the channel component P31, the time component P32 and the program contents component P33, for example) included in the GUI component is referred to as lower components.

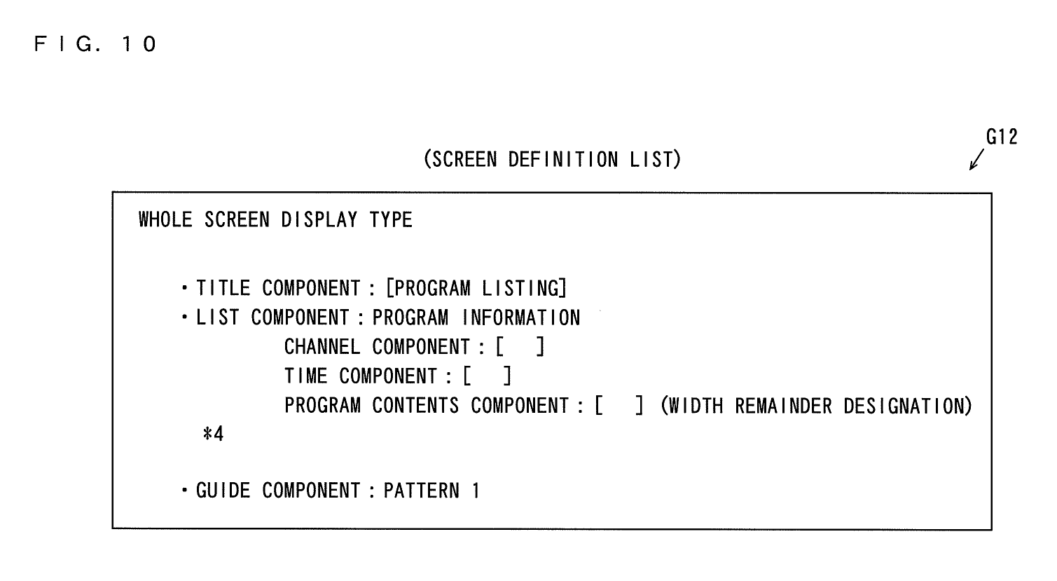

FIG. 10 is a diagram schematically showing the screen definition list corresponding to the GUI image V2 of FIG. 9. As shown in FIG. 10, the display type of the GUI image V2, the type of the GUI components of the GUI image V2, the type of the lower components of the GUI image V2, and the characters inserted in each GUI component and each lower component are shown in the screen definition list G12. The characters inserted in the channel component P31, the time component P32 and the program contents component P33 (the characters in brackets of FIG. 10) are produced based on EPG (Electronic Program Guide) data extracted from a digital broadcast signal. The characters indicating a channel, time and program contents of a program are inserted in the channel component P31, the time component P32 and the program contents component P33, respectively.

In addition, a width remainder designation is given to the program contents component in the screen definition list G12. Details of the width remainder designation will be described later. Note that “*4” in FIG. 10 indicates that the four list components exist.

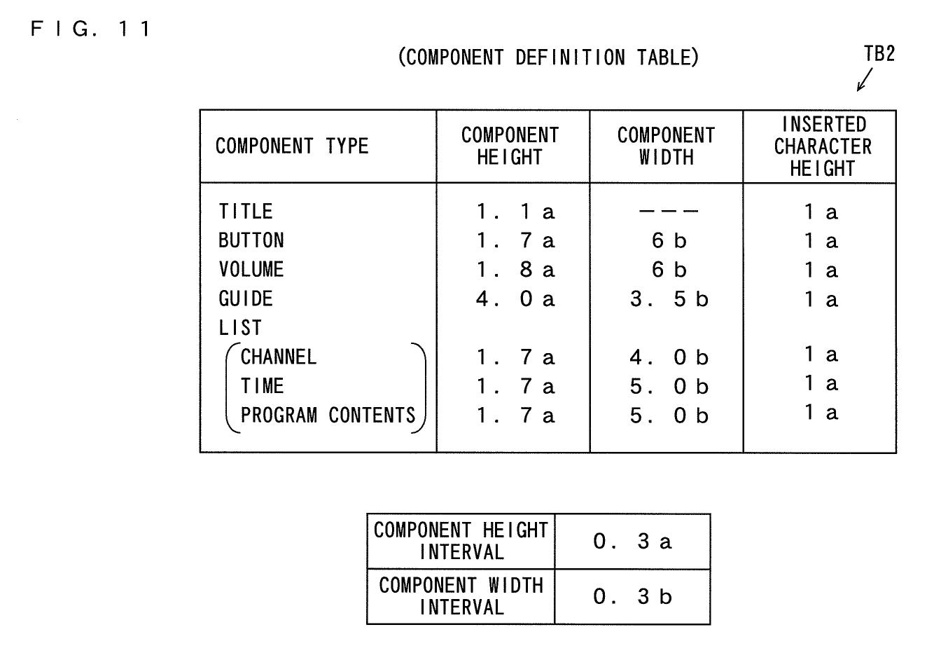

FIG. 11 is a diagram showing the specific example of the component definition table TB2. As shown in FIG. 11, the heights and widths of the various GUI components, the heights and widths of the various lower components and the heights of the inserted characters are defined using the reference height a and the reference width b in the component definition table TB2. In addition, an interval in a height direction between the adjacent GUI components (hereinafter referred to as a component height interval) and an interval in a width direction (hereinafter referred to as a component width interval) are defined using the reference height a and the reference width b in the component definition table TB2.

### (5) GUI Display Processing

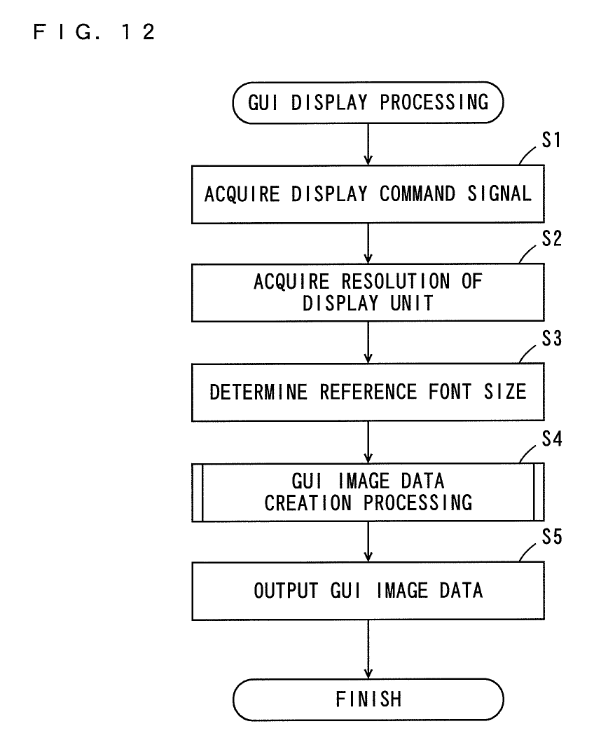

Description will now be made of one example of the GUI display processing performed by the CPU 4. The GUI display processing is executed by the CPU 4 according to the GUI display processing program stored in the ROM 2. FIGS. 12 to 16 are flowcharts showing one example of the GUI display processing performed by the CPU 4.

As shown in FIG. 12, the CPU 4 starts the GUI display processing by acquiring the display command signal from the light receiver 7 (Step S1). First, the CPU 4 acquires the resolution of the display unit 10 from the model information of the display unit 10 stored in the NVRAM 3 (Step S2). Next, the CPU 4 determines the reference font size corresponding to the resolution of the display unit 10 based on the reference font size definition table TB1 of the ROM 2 (Step S3).

Then, the CPU 4 performs GUI image data creation processing based on the screen definition lists G1, G2, . . . , Gn of the ROM 2, the component definition table TB2 and the determined reference font size (Step S4). Details of the GUI image data creation processing will be described later. Next, the CPU 4 outputs the created GUI image data (Step S5). The image processor 6 (FIG. 1) draws the GUI image based on the GUI image data output from the CPU 4. This causes the GUI image to be displayed on the display unit 10.

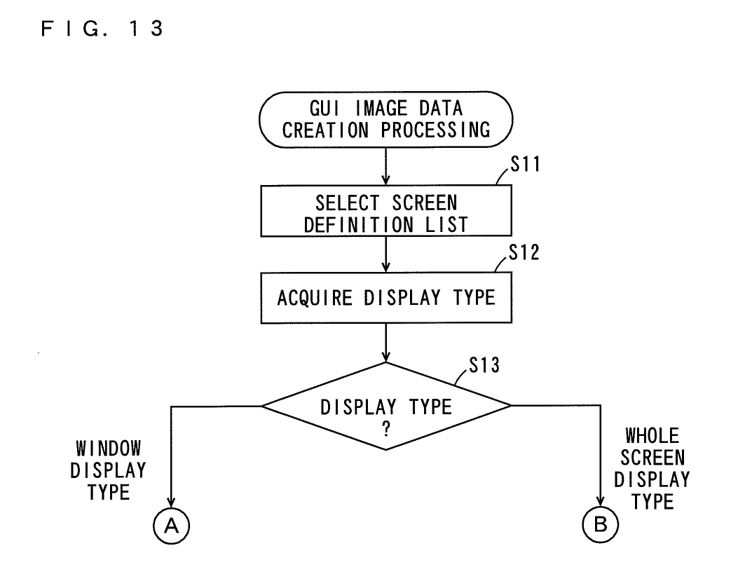

Hereinafter, description is made of details of the GUI image data creation processing of Step S4. As shown in FIG. 13, the CPU 4 selects one screen definition list from the screen definition lists G1, G2, . . . , Gn based on the display command signal from the light receiver 7 (Step S11), and acquires the display type of the GUI image from the screen definition list (Step S12).

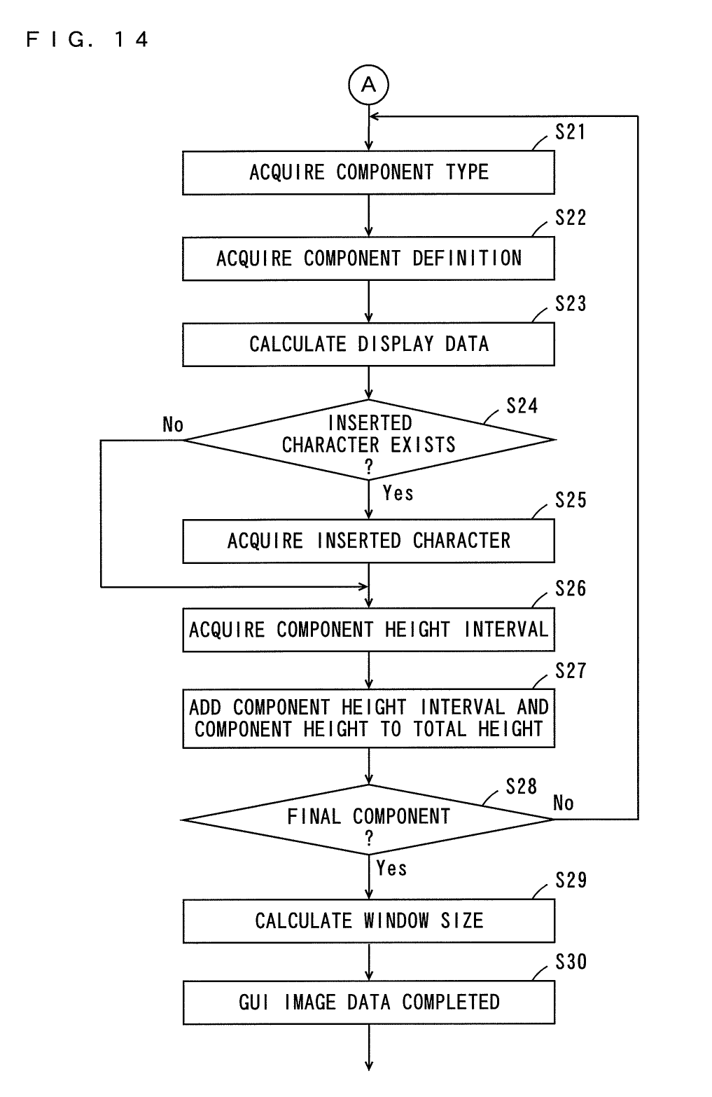

When the acquired display type is the window display type, the CPU 4 acquires the type of the GUI components from the screen definition list (Step S21) as shown in FIG. 14. In the example of FIGS. 7 and 8, the button component P12, for example, is acquired from the screen definition list G11 as the type of the GUI components.

Next, the CPU 4 acquires the definition of the GUI component from the component definition table TB2 (Step S22). In the example of FIGS. 7 and 8, the height (1.7a) and the width (6b) of the button component P12 and the height (1a) of the inserted character, for example, are acquired from the component definition table TB2 of FIG. 11.

The CPU 4 subsequently calculates the display data of the GUI component in dot units as shown in FIGS. 4 and 5 based on the reference font size determined in Step S3 and the definition of the GUI component acquired in Step S22 (Step S23). In the example of FIGS. 7 and 8, the height and width of the button component P12 and the height and width of the inserted character, for example, are calculated in dot units.

Then, the CPU 4 determines whether or not the inserted character exists in the GUI component based on the screen definition list (Step S24). When the inserted character does not exist in the GUI component, the CPU 4 proceeds to the process of Step S26. When the inserted character exists in the GUI component, the CPU 4 acquires the inserted character from the screen definition list (Step S25) and converts the height and width of the acquired inserted character into dot units based on the display data calculated in Step S23. In the example of FIGS. 7 and 8, “adjustment” is acquired as the inserted character of the button component P12, for example, and converted into dot units.

The CPU 4 subsequently acquires the component height interval from the component definition table TB2 and converts the acquired component height interval into dot units based on the reference font size (Step S26). In the example of FIGS. 7 and 8, the component height interval (0.3a) is acquired from the component definition table TB2 to be converted into dot units.

Then, the CPU 4 adds the component height interval and the height of the GUI component to a total height (Step S27). Note that an initial value of the total height is zero. In the example of FIGS. 7 and 8, the component height interval and the height of the button component P12, for example, are added to the height of the title component P11 that has been already acquired.

Next, the CPU 4 determines whether or not the acquired GUI component is a final GUI component based on the screen definition list (Step S28). When the acquired GUI component is not the final GUI component, the CPU 4 returns to the process of Step S21. When the acquired GUI component is the final GUI component, the CPU 4 determines the height and width of the window on which the GUI image is displayed (Step S29). Specifically, the CPU 4 determines the height of the window based on the total height, and determines the width of the window based on the GUI component having the largest width among the acquired GUI components.

In the example of FIGS. 7 and 8, the height of the window is determined based on the total of the heights of the title component P11, the button components P12, P13, the volume component P14 and the guide component P15 and the component height interval between the GUI components arranged one above another. In addition, the width of the window is determined based on the width of each of the button components P12, P13, and the volume component P14.

Accordingly, the GUI image data is completed (Step S30), and the CPU 4 proceeds to the process of Step S5 shown in FIG. 12.

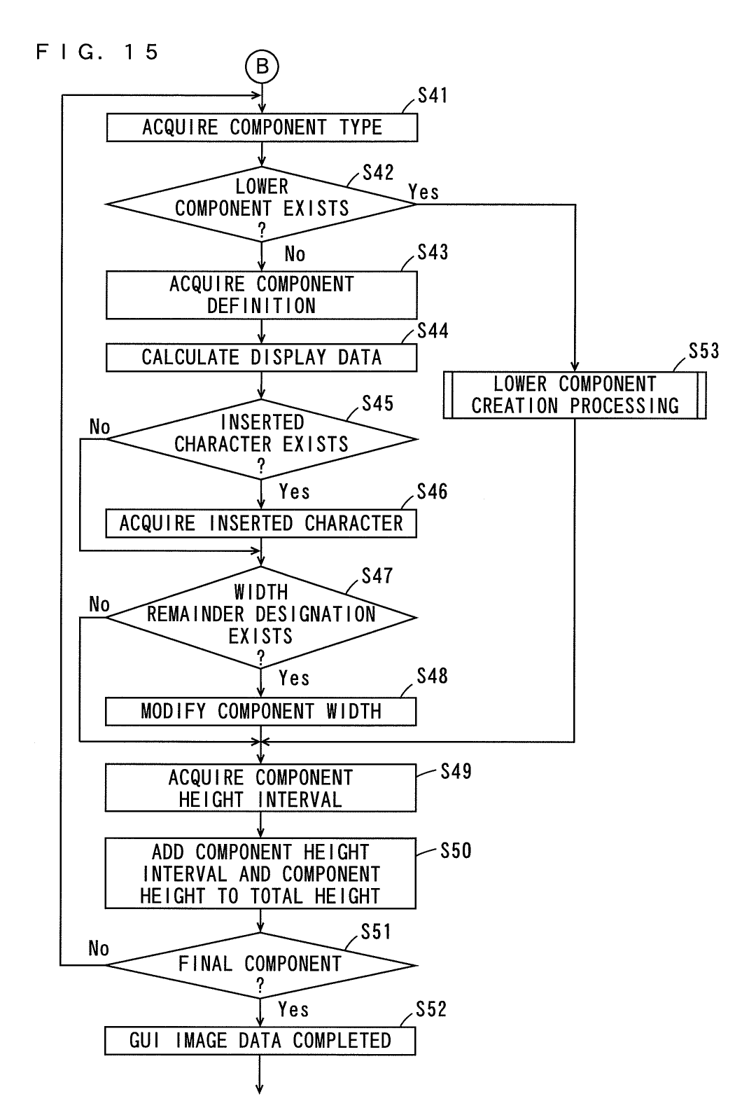

In Step S13 of FIG. 13, when the acquired display type is the whole screen display type, the CPU 4 acquires the type of the GUI components from the screen definition list as shown in FIG. 15 (Step S41). In the example of FIGS. 9 and 10, the list component P22, for example, is acquired from the screen definition list G12 as the type of the GUI components.

Next, the CPU 4 determines whether or not the lower component is included in the acquired GUI component (Step S42). When the lower component is included in the GUI component, the CPU 4 performs lower component creation processing, described later (Step S53).

When the lower component is not included in the GUI component, the CPU 4 acquires the definition of the GUI component (Step S43). As shown in FIGS. 4 and 5, the CPU 4 subsequently calculates the display data of the GUI component in dot units based on the reference font size determined in Step S3 and the definition of the GUI component acquired in Step S43 (Step S44).

The CPU 4 then determines whether or not the inserted character exists in the GUI component based on the screen definition list (Step S45). When the inserted character does not exist in the GUI component, the CPU 4 proceeds to the process of Step S47. When the inserted character exists in the GUI component, the CPU 4 acquires the inserted character from the screen definition list (Step S46) and converts the height and width of the acquired inserted character into dot units based on the display data calculated in Step S44.

Next, the CPU 4 determines whether or not the width remainder designation exists in the GUI component based on the screen definition list (Step S47). When the width remainder designation does not exist in the GUI component, the CPU 4 proceeds to the process of Step S49. When the width remainder designation exists in the GUI component, the width of the GUI component is modified by the CPU 4 so as to be substantially equal to the width of the screen of the display unit 10 (Step S48). In this case, a blank portion on the screen of the display unit 10 can be reduced.

The CPU 4 subsequently acquires the component height interval from the screen definition list and converts the acquired component height interval into dot units based on the reference font size (Step S49).

Next, the CPU 4 adds the component height interval and the height of the GUI component to the total height (Step S50). Note that the initial value of the total height is zero. The CPU 4 then determines whether or not the acquired GUI component is the final GUI component based on the screen definition list (Step S51). When the acquired GUI component is not the final GUI component, the CPU 4 returns to the process of Step S41. When the acquired GUI component is the final GUI component, the GUI image data is completed (Step S52). The CPU 4 then proceeds to the process of Step S5 shown in FIG. 12.

Hereinafter, detail description is made of the lower component creation processing (Step S53). Note that the lower component creation processing shown below is performed at the time of acquirement of the list components P22, P23, P24, P25 in the example of FIGS. 9 and 10.

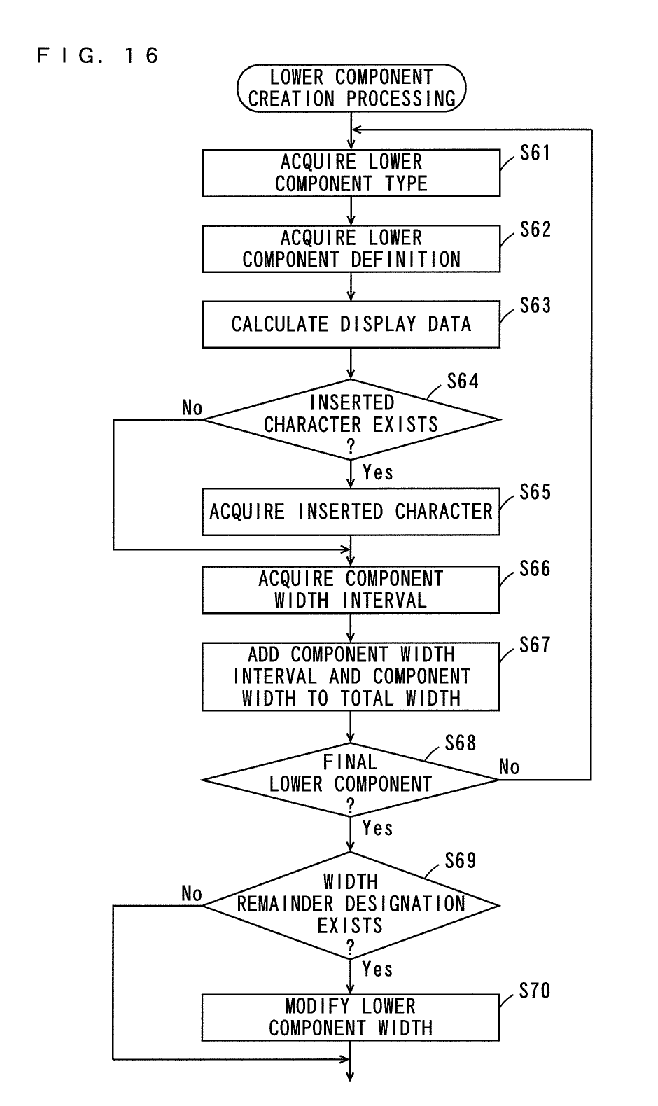

As shown in FIG. 16, the CPU 4 acquires the type of the lower components from the screen definition list (Step S61). In the example of FIGS. 9 and 10, the channel component P31, for example, is acquired from the screen definition list G12 as the type of the lower components.

Next, the CPU 4 acquires the definition of the lower component from the component definition table TB2 (Step S62). In the example of FIGS. 9 and 10, the height (1.7a) and the width (4b) of the channel component P31 and the height (1a) of the inserted character, for example, are acquired from the component definition table TB2 of FIG. 11.

Then, as shown in FIGS. 4 and 5, the CPU 4 calculates the display data of the GUI component in dot units based on the reference font size determined in Step S3 and the definition of the lower component acquired in Step S62 (Step S63). In the example of FIGS. 9 and 10, the height and width of the channel component P31 and the height and width of the inserted character, for example, are calculated in dot units.

The CPU 4 then determines whether or not the inserted character exists in the lower component based on the screen definition list (Step S64). When the inserted character does not exist in the lower component, the CPU 4 proceeds to the process of Step S66. When the inserted character exists in the lower component, the CPU 4 acquires the inserted character from the screen definition list and converts the height and width of the acquired inserted character into dot units based on the display data calculated in Step S63 (Step S65). In the example of FIGS. 9 and 10, “10” produced based on the EPG data is acquired as the inserted character of the channel component P31, for example, and converted into dot units.

Next, the CPU 4 acquires the component width interval from the screen definition list, and converts the acquired component width interval into dot units based on the reference font size (Step S66). In the example of FIGS. 9 and 10, the component width interval (0.3a) is acquired from the component definition table TB2, and converted into dot units.

The CPU 4 then adds the component width interval and the width of the lower component to the total width (Step S67). Note that an initial value of the total width is zero. In the example of FIGS. 9 and 10, the total of the component width interval and the width of the channel component P31, for example, is set as the total width.

The CPU 4 subsequently determines whether or not the acquired lower component is the final lower component in the corresponding GUI component based on the screen definition list (Step S68). When the acquired lower component is not the final lower component, the CPU 4 returns to the process of Step S61. When the acquired lower component is the final lower component, the CPU 4 determines whether or not the width remainder designation exists in the lower component (Step S69).

When the width remainder designation does not exist in the lower component, the CPU 4 finishes the lower component creation processing and proceeds to the process of Step S49 of FIG. 15. When the width remainder designation exists in the lower component, the CPU 4 modifies the width of the final lower component such that the total width is substantially equal to the width of the screen of the display unit 10 (Step S70).

In the example of FIGS. 9 and 10, the width remainder designation is given to the program contents component P33. In this case, the width of the program contents component P33 is extended, so that the total of the widths of the channel component P31, the time component P32 and the program contents component P33 and the component width interval between the lower components arranged side by side is substantially equal to the width of the screen of the display unit 10.

In this manner, the GUI image data of the window display type and the whole screen display type is created.

While only the GUI image of the whole screen display type includes the lower components in the foregoing example, the GUI image of the window display type may include the lower components. In this case, the same processing as the lower component creation processing of Step S53 is performed when the GUI image data of the window display type is created.

While the component height interval and the component width interval are set to constant values in the foregoing example, the component height interval and the component width interval may be set to different values depending on the types of the GUI components or the lower components, and so on.

### (6) Effects of the Present Embodiment

In the present embodiment, the display data such as the height and width of each GUI component is calculated in dot units based on the reference font size corresponding to the resolution of the display unit 10. Accordingly, the GUI image with high definition can be displayed on the display unit 10 having various resolutions.

In addition, since the GUI image corresponding to the various resolutions can be created by the processing based on the common screen definition list, a plurality of programs or a plurality of screen definition lists corresponding to the respective resolutions need not be created. This significantly reduces the number of steps of developing and testing the program and the screen definition list.

In the present embodiment, respective display positions of the GUI components are sequentially calculated such that the plurality of GUI components are arranged in the height direction or the width direction on the screen. In this case, the respective display positions of the GUI components on the screen need not be preset in the absolute coordinate on the screen. This further reduces the numbers of steps of developing and testing the program and the screen definition list.

### (7) Other Embodiments

Although description is made of the case where the GUI image is displayed in the foregoing embodiment, the present invention is not limited to this. The same processing as that in the foregoing embodiment may be performed for providing on-screen display (OSD) of other graphic images such as characters, numbers, signs and figures on video.

The display processing apparatus 100 may be mounted on a television broadcast receiver such as a digital television or on a DVD (Digital Versatile Disk) reproducing apparatus, a DVD recording/reproducing apparatus, a hard disk recording/reproducing apparatus, a set-top box, a personal computer or the like.

### (8) Correspondences between Elements in the Claims and Parts in Embodiments

In the following paragraph, non-limiting examples of correspondences between various elements recited in the claims below and those described above with respect to various preferred embodiments of the present invention are explained.

In the foregoing embodiments, the GUI image is an example of a graphic image, the GUI component is an example of a display component, the image definition lists G1, G2, . . . , Gn are examples of display information, the reference font size is an example of a reference size, the component definition table TB2 is an example of component information, the ROM 2 is an example of a display information storage, a reference size storage and a component information storage, the NVRAM 3 is an example of a resolution acquirer, the CPU 4 is an example of a reference size acquirer, a display data generator, a display position calculator and a display region calculator.

As each of various elements recited in the claims, various other elements having configurations or functions described in the claims can be also used.

### INDUSTRIAL APPLICABILITY

The present invention can be effectively utilized in a television receiver, a personal computer, a DVD recorder, a projector and so on.

1. A display processing apparatus that performs processing for displaying a graphic image on a screen of a display device, comprising:
a display information storage storing display information that defines a display component constituting the graphic image to be displayed on the screen;
a reference size storage storing values of reference sizes that are preset for a plurality of resolutions and correspond to the respective resolutions;
a component information storage storing component information that defines a size of the display component for each type of the display component;
a resolution acquirer acquiring a resolution of the screen of said display device;
a reference size acquirer acquiring the value of the reference size corresponding to the resolution acquired by said resolution acquirer from said reference size storage; and
a display data generator calculating the size of the display component defined by the display information stored in said display information storage based on the value of the reference size acquired by said reference size acquirer and the component information stored in said component information storage, and generating display data for displaying the display component based on the calculated size.

2. The display processing apparatus according to claim 1, wherein the component information defines the size of the display component by a variable of the reference size.

3. The display processing apparatus according to claim 2, further comprising a display position calculator calculating a display position of the display component on the screen based on the size of the display component calculated by said display data generator.

4. The display processing apparatus according to claim 3, wherein said display position calculator sequentially calculates, when the graphic image to be displayed on the screen includes a plurality of display components, display positions of the display components such that the plurality of display components are sequentially arranged on the screen with a predetermined reference position on the screen as a reference based on the size of each display component calculated by said display data generator.

5. The display processing apparatus according to claim 2, wherein
said graphic image is displayed in a display region formed in at least part of the screen, and
said display processing apparatus further comprising a display region calculator that calculates a size of said display region based on the size of the display component calculated by said display data generator.

6. The display processing apparatus according to claim 2, further comprising a size modifier that modifies the size of the display component calculated by said display data calculator such that a margin of said display region calculated by said display region calculator is reduced.

7. The display processing apparatus according to claim 2, wherein said reference size includes a reference height and a reference width in dot units.

8. A display processing method for performing processing for displaying a graphic image on a screen of a display device, comprising the steps of:
storing display information that defines a display component constituting a graphic image to be displayed on the screen;
storing values of reference sizes that are preset for a plurality of resolutions and correspond to the respective resolutions;
storing component information that defines a size of the display component for each type of the display component;
acquiring a resolution of the screen of said display device;
determining the value of the reference size corresponding to the acquired resolution based on the values of the reference sizes corresponding to the plurality of resolutions that have been stored; and
calculating the size of the display component defined by the stored display information based on the determined value of the reference size and the stored component information, and generating the display data for displaying the display component based on the calculated size.

9. The display processing method according to claim 8, wherein the component information defines the size of the display component by a variable of the reference size.

10. A display processing program that can be executed by a processing apparatus that performs processing for displaying a graphic image on a screen of a display device, causing said processing apparatus to execute the processes of:
storing display information that defines a display component constituting a graphic image to be displayed on the screen;
storing values of reference sizes that are preset for a plurality of resolutions and correspond to the respective resolutions;
storing component information that defines a size of a display component for each type of the display component;
acquiring a resolution of the screen of said display device;
determining the value of the reference size corresponding to the acquired resolution based on the values of the reference sizes corresponding to the plurality of resolutions that have been stored; and
calculating the size of the display component defined by the stored display information based on the determined value of the reference size and the stored component information, and generating the display data for displaying the display component based on the calculated size.

11. The display processing program according to claim 10, wherein the component information defines the size of the display component by a variable of the reference size.
